(19) United States
(12) Patent Application Publication
(10) Pub. No.: US 2017/0173856 A1
(43) Pub. Date: Jun. 22, 2017

(54) METHOD OF MANUFACTURING A FOLDING MAT AND A FOLDING MAT MADE BY THE SAME

(71) Applicant: TreeLine Co., Ltd., Seongnam-si (KR)

(72) Inventors: Bong Yong Park, Seongnam-si (KR); Hyun Ki Song, Yongin-si (KR); Seok Ho Lee, Gimpo-si (KR)

(21) Appl. No.: 15/381,805

(22) Filed: Dec. 16, 2016

(30) Foreign Application Priority Data
Dec. 16, 2015 (KR) 10-2015-0180132

(51) Int. Cl. B29C 65/14; B29C 69/00; B29C 65/00

(52) U.S. Cl. CPC B29C 65/14; B29C 66/1312; B29C 66/73921; B29C 69/001; B29C 66/1142; B29K 2423/06; B29K 2075/00

(57) ABSTRACT

A method of manufacturing a folding mat includes: suctioning a first film onto a lower mold, in which a downwardly concave slit groove is formed at one end of a cavity such that a portion of the first film forms a unit fold part; inserting the unit filler over the first film; disposing a second film on an upper side of the lower mold to cover the unit filler; attaching the edge parts of the first and the second films together by using an upper mold mating with the lower mold; trimming an attachment part of the unit mats thus fabricated; fusing the unit fold part of the unit mat with the unit fold part of an adjacent unit mat; and fusing the attachment part of one of the two unit mats thus connected with the attachment part or the unit fold part of another unit mat.

### CROSS-REFERENCE TO RELATED APPLICATIONS

This application claims the benefit of Korean Patent Application No. 10-2015-0180132, filed with the Korean Intellectual Property Office on Dec. 16, 2015, the disclosure of which is incorporated herein by reference in its entirety.

### BACKGROUND

1. Technical Field

The present invention relates to a folding mat and a manufacturing method thereof, more particularly to a folding mat and a method of manufacturing the folding mat which folds multiple times.

2. Description of the Related Art

Generally, a folding mat may entail multiple unit mats that can be folded in a zigzag form for storage. As this can minimize the space occupied, it is easier to stack and store the mat. Because of this high level of utility even in narrow spaces, it is especially popular with single persons or camping enthusiasts and is used in a variety of forms by other groups of people.

As illustrated in FIGS. 1A and 1B, such a folding mat according to the related art may include a multiple number of unit outer skins 2 connected to fold in a zigzag fashion, where each unit outer skin 2 holds a unit filler 1 that is shaped as a rectangular block of a particular thickness. Here, the unit outer skins 2 may be connected by way of strip-like connector pieces 4, 5 that are independent of the unit outer skins 2, while zippers 3 for inserting and withdrawing the unit fillers 1 may be formed in the sides of the unit outer skins 2.

However, in such type of folding mat based on the related art, the unit outer skins 2 with zippers 3 are mostly made of fabric, so that if water or some sort of beverage is spilled on a unit outer skin 2, the unit filler 1 within may also get wet. Since the unit filler 1 is generally made from a urethane foam member, etc., and absorbs water, it may not easily dry, posing problems to the user in outdoor applications such as camping, etc. Of course, there is also the hassle of having to wash the fabric unit outer skin 2 when it gets dirty. In addition, the unit outer skins 2 may have to be attached with the connector pieces 4, 5; that is, it may be required to attach both sides (along the widthwise direction) of the relatively narrow connector pieces 4, 5 to the respective unit outer skins 2. Such a complicated process, not to mention the inclusion of an additional process itself, may lower productivity. Even if the unit outer skins 2 are molded from a vinyl material for waterproofing, there still remains the problem of having to join the unit outer skins 2 with the connector pieces 4, 5.

### PRIOR ART DISCLOSURE

Korean Utility Model Publication No. 20-1999-006557

### SUMMARY OF THE INVENTION

To resolve the problems described above, an aspect of the invention aims to provide a folding mat that is both manufactured by a simple process and made of a waterproof material, to provide improved convenience by allowing the user to easily wipe off any spills on the outer surface.

According to a feature of the invention, a method of manufacturing a folding mat may be provided, for a folding mat that includes multiple unit mats 10, with each of the unit mats 10 comprising a unit filler 20 shaped as a quadrilateral block and a unit outer skin 30 enveloping the unit filler 20, and with the unit mats 10 stacked in a zigzag form by way of a first and a second fold part 31, 32 formed on an upper end on one side and a lower end on the other side of the unit outer skin 30. The manufacturing method may include: suctioning a first film 40 onto a lower mold 60, in which a downwardly concave slit groove 62 extends in a lengthwise direction at one end of a bottom surface of a quadrilateral cavity 61, where the first film 40 is suctioned to be in tight contact with the bottom surface of the cavity 61, an inner wall of the slit groove 62, and an entrance periphery of the slit groove 62, such that a portion of the first film 40 placed in tight contact with the slit groove 62 forms a unit fold part 41; inserting the unit filler 20 over the first film 40 placed in tight contact with the cavity 61 of the lower mold 60; disposing a second film 50 on an upper side of the lower mold 60 to cover the unit filler 20 such that an edge part 50a of the second film 50 overlaps an edge part 40a of the first film 40 positioned in the entrance periphery of the cavity 61 of the lower mold 60; attaching the edge parts 40a, 50a of the first and the second films 40, 50 together by using an upper mold 70 mating with the lower mold 60; trimming an attachment part 33 of the unit mats 10 thus fabricated, such that all of or a portion of the attachment part 33 is trimmed; fusing the unit fold part 41 of the unit mat 10 with the unit fold part 41 of an adjacent unit mat 10 by way of heat or high-frequency waves; and fusing the attachment part 33 of one of the two connected unit mats 10 with the attachment part 33 or the unit fold part 41 of another unit mat 10 by way of heat or high-frequency waves.

According to another feature of the invention, a method of manufacturing a folding mat can be provided, where the unit filler 20 is made from a polyethylene expanded foam member, the first and the second films 40, 50 forming the unit outer skin 30 are made from thermoplastic polyurethane (TPU), and the attachment part 33 of the first and second films 40, 50 is formed by the edge parts 40a, 50a fused together by high-frequency fusion.

According to another feature of the invention, a folding mat may be provided that is manufactured by a method such as those described above.

According to an embodiment of the invention, a unit mat 10 may be manufactured by suctioning a first film 40 onto a lower mold 60, in a cavity 61 of which a slit groove 62 is formed at one end in the bottom surface; inserting a unit filler 20 of a particular thickness; stacking a second film 50 thereupon; and attaching the edge parts 40a, 50a of the first and second films 40, 50 by way of an upper mold 70. In a unit mat 10 manufactured in this manner, an attachment part 33 may be formed at the upper end or lower end on one side, while a unit fold part 41 implemented by the portion of the first film 40 inserted in the slit groove 62 of the lower mold 60 may be formed at the lower end or upper end on the other side, so that fusing the attachment parts 33 and unit fold parts 41 can provide a zigzag configuration for the unit mats 10.

A folding mat manufactured in this manner according to an embodiment of the invention has its unit outer skin 30 made from a first and a second film 50 and thus can provide better waterproofing compared to the conventional unit outer skin made from fabric. The folding mat provides improved user convenience in that, if a beverage, etc., is spilled on the folding mat, it can simply be wiped clean and does not require separate washing.

Also, a portion of the first film 40 can be made into a unit fold part 41 by way of the slit groove 62 in the lower mold 60, in addition to the attachment parts 33 of the first and second films 40, 50. As the attachment part 33 and the unit fold part 41 can be formed in a zigzag form on both sides of a single unit outer skin 30, the unit mats 10 having a predetermined thickness can be connected to allow easy folding in a zigzag form. Accordingly, the gaps between the unit mats 10 of predetermined thickness can be minimized, and since there is no need for an additional process for attaching the strip-shaped connector pieces on the other side of the unit mat 10 where there is no attachment part 33, the manufacturing procedure can be simplified, productivity can be improved, and the quality of the product can also be enhanced.

By forming the unit filler 20 from a polyurethane expanded foam member, an environmentally friendly material, the risk of illnesses such as atopy, etc., can be mitigated. Also, the first and second films 40, 50 can be made from thermoplastic polyurethane (TPU) to provide light weight and adequate hardness while enabling easy thermal or high-frequency fusion. The edge parts 40a, 50a of the first and second films 40, 50 can be attached in a simple manner by way of high-frequency fusion.

Additional aspects and advantages of the present invention will be set forth in part in the description which follows, and in part will be obvious from the description, or may be learned by practice of the invention.

### BRIEF DESCRIPTION OF THE DRAWINGS

FIG. 1A and FIG. 1B is a perspective view and a cross-sectional view illustrating an example of a folding mat according to the related art.

FIG. 2 is a perspective view illustrating a folding mat according to an embodiment of the invention.

FIG. 3 is a cross-sectional view of the folding mat a folding mat according to an embodiment of the invention.

FIG. 4 is a diagram illustrating a procedure for manufacturing a folding mat according to an embodiment of the invention.

FIG. 5A, FIG. 5B, FIG. 5C, FIG. 6A, FIG. 6B, FIG. 6C, FIG. 7A, and FIG. 7B provide a flow diagram illustrating a procedure for manufacturing a folding mat according to an embodiment of the invention.

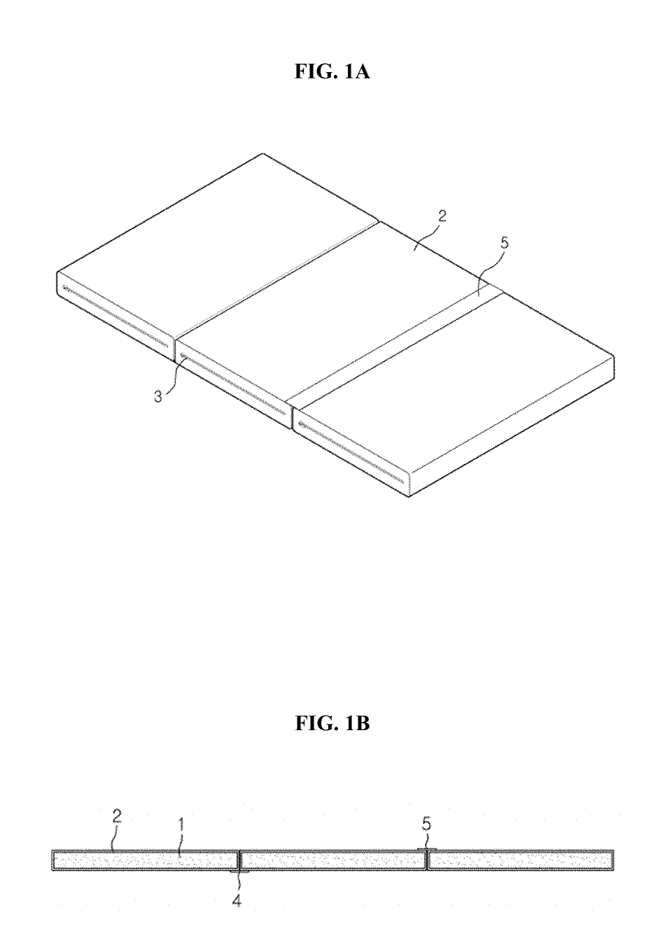

### DETAILED DESCRIPTION OF THE INVENTION

The objectives, characteristics, and advantages of the present invention mentioned above will become more clearly understood from the detailed descriptions provided below. Certain embodiments of the invention are described below with reference to the accompanying drawings.

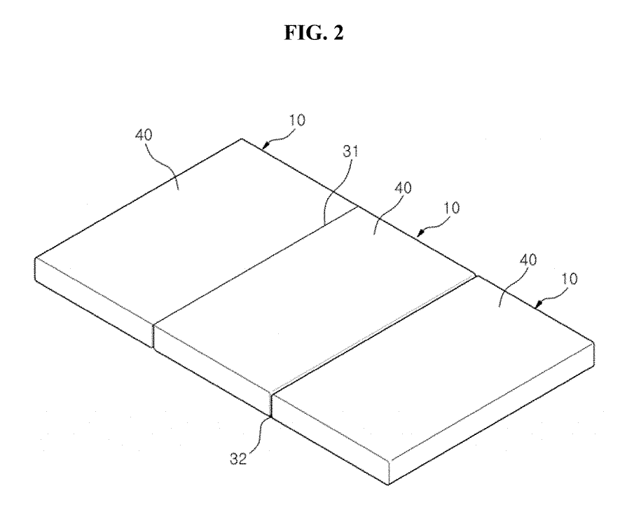

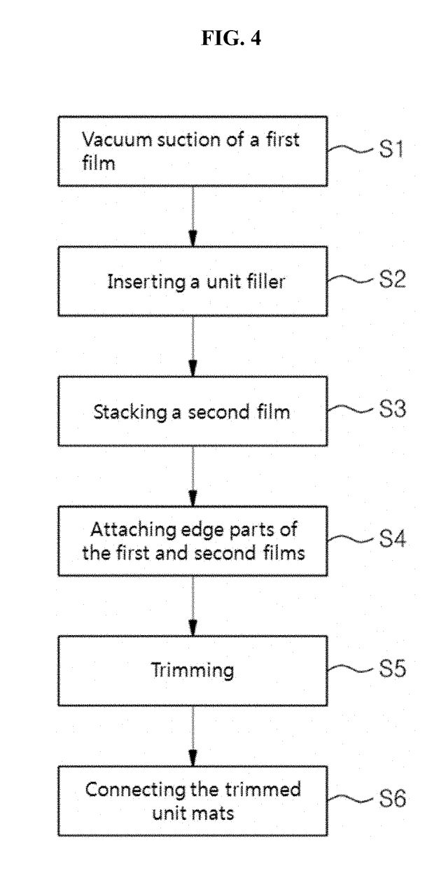

FIG. 2 through FIG. 7B illustrate a folding mat and a method of manufacturing the folding mat according to an embodiment of the invention. As illustrated in the drawings, a method of manufacturing a folding mat according to an embodiment of the invention may include suctioning a first film 40 onto a cavity 61 in a lower mold 60 (S1), inserting a unit filler 20 over the first film 40 that is suctioned into tight contact with the cavity 61 of the lower mold 60 (S2), disposing a second film 50 on an upper surface of the unit filler 20 (S3), attaching the edge parts 40a, 50a of the first and second films 40, 50 by using an upper mold 70 (S4), trimming the attached portions (S5), and connecting the unit mats 10 fabricated as above (S6).

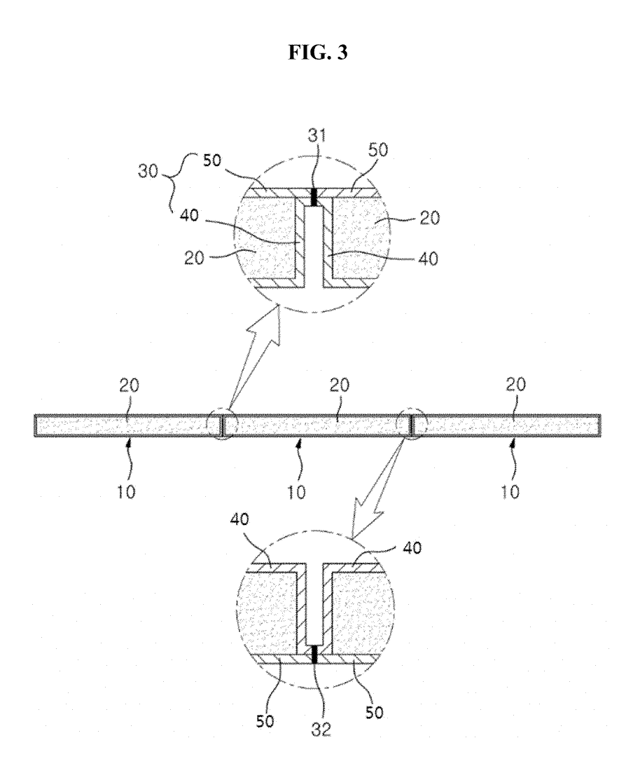

As shown in FIG. 2 and FIG. 3, a folding mat may include a multiple number of unit mats 10, which may include multiple unit fillers 20 shaped as quadrilateral blocks and unit outer skins 30 that envelope the respective unit fillers 20, with the unit mats 10 stacked in a zigzag form by way of a first and a second fold part 31, 32 formed on an upper end on one side and a lower end on the other side of the unit outer skin 30.

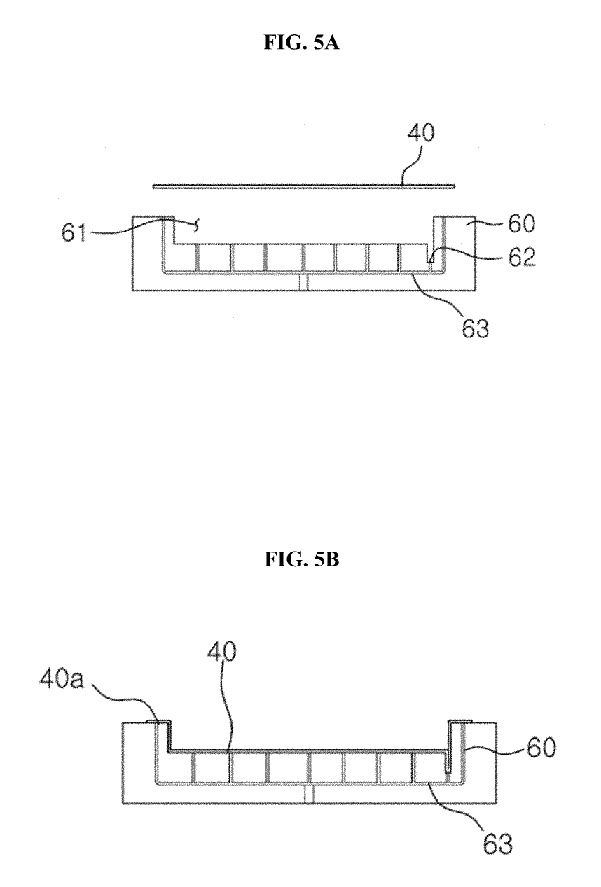

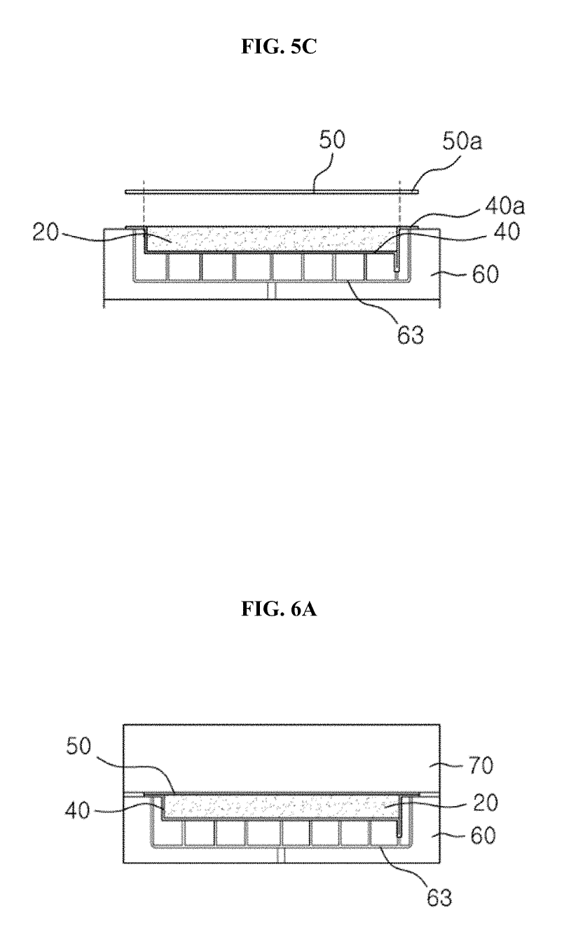

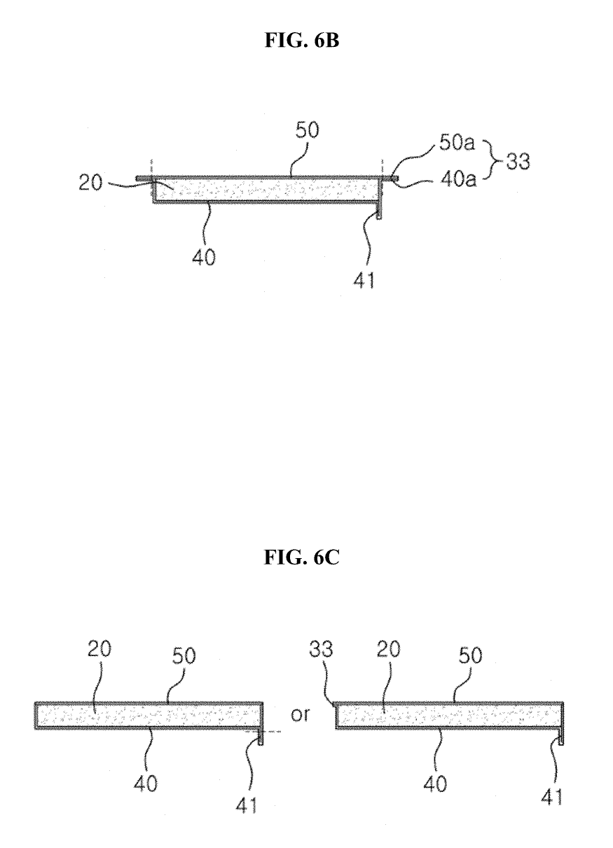

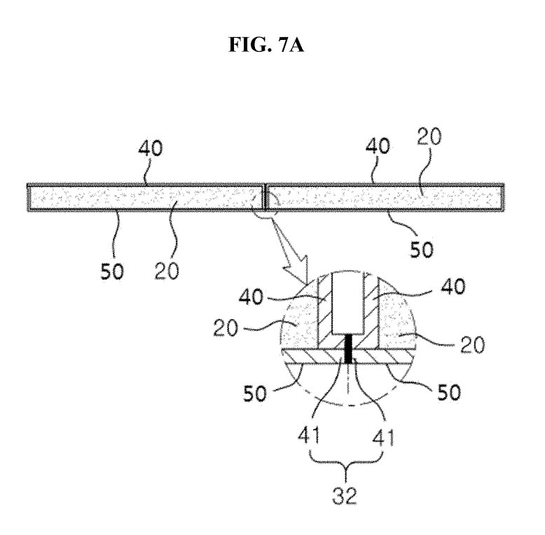

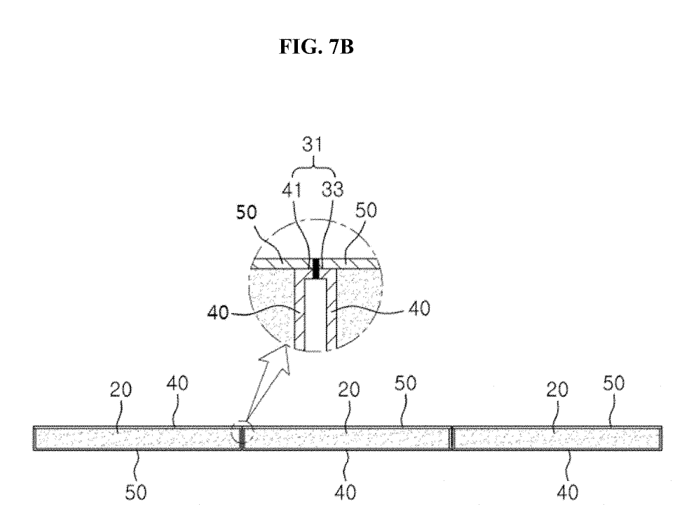

Operation S1 may include suctioning the first film 40 onto the cavity 61 of the lower mold 60, as illustrated in FIGS. 5A and 5B. Here, the lower mold 60 may have a cavity 61 having a quadrilateral cross section formed in its upper side, and at one end of the bottom surface of this cavity 61, a downwardly concave slit groove 62 may extend along the lengthwise direction. Also, vacuum suction paths 63 may be formed in the lower mold 60 for suctioning the first film 40 onto the cavity 61, with the vacuum suction paths 63 formed even in the slit groove 62. Thus, the portion of the first film 40 suctioned into the slit groove 62 may form a unit fold part 41 on one side of the unit mat 10 for the first and second fold parts 31, 32 connecting the unit mats 10. The first film 40 may also be suctioned onto the periphery around the entrance of the cavity 61 in the lower mold 60, and this portion may form an edge part 40a.

Operation S2 may include inserting the unit filler 20 in the cavity 61 of the lower mold 60 while the first film 40 is being suctioned, as shown in FIG. 5C. Here, the unit filler 20, placed on an upper surface of the first film 40, may be made by expansion foam molding into the shape of a quadrilateral block having a particular thickness, as described above, and may preferably be made from a polyethylene expanded foam member since this is an environmentally friendly material that does not discharge endocrine disruptors, etc.

Operation S3 may include stacking the second film 50 over an upper surface of the unit filler 20, i.e. over an upper side of the cavity 61 of the lower mold 60, as illustrated in FIG. 5C. Here, the second film 50 may be stacked such that the boundary of the second film 50 overlaps the edge part 40a of the first film 40, and this overlapping boundary of the second film 50 may form an edge part 50a.

The first and second films 40, 50 may form an outer skin 30 that envelopes the unit filler 20. The first and second films 40, 50 may preferably be made of thermoplastic polyethylene (TPU), as it is light and hard while allowing easy attaching of the boundary when applying heat.

Operation S4 may include attaching the edge parts 40a, 50a of the first and second films 40, 50 by using an upper mold 70 that mates with the lower mold 60, as illustrated in FIG. 6A. Here, the edge parts 40a, 50a of the first and second films 40, 50 may be fused more simply by high-frequency heat, and as shown in FIG. 6B, the fused portion may form an attachment part 33. Thus, as the unit filler 20 is enveloped by an outer skin 30 formed by the first and second films 40, 50 joined together, a unit mat 10 may be obtained. Such a unit mat 10 may have a unit fold part 41 formed at a lower end on one side and an attachment part 33 formed at an upper end on the sides, as shown in FIG. 6B.

Operation S5 may include trimming the attachment part 33 of the unit mat 10, as illustrated in FIG. 6C. Here, the attachment part 33 formed over the entire boundary of the unit mat 10 can be trimmed off completely, as in the first drawing of FIG. 6C, or can be trimmed such that a portion remains, as in the second drawing of FIG. 6C. That is, when multiple unit mats 10 are connected such that they are stackable in a zigzag form, a unit mat 10 positioned in a middle portion can have the attachment part 33 trimmed such that a portion of the attachment part 33 remains, whereas a unit mat 10 positioned at the side can have all of the attachment part 33 trimmed off. When an attachment part 33 is trimmed such that a portion thereof remains, then the trimming may be performed such that, if the unit fold part 41 is formed at the upper end or lower end on one side of the unit mat 10, the attachment part 33 is formed at the lower end or upper end on the other side of the unit mat 10, as illustrated in the second drawing of FIG. 6C.

Operation S6 may include connecting the trimmed unit mats 10 such that they may be stacked in a zigzag form, as illustrated in FIGS. 7A and 7B. First, as shown in FIG. 7A, the unit fold part 41 of a unit mat 10 on one side may be fused, by way of heat or high-frequency waves, with the unit fold part 41 of a unit mat 10 on the other side. Here, the portion where the unit fold parts 41 are fused together may form the first or second fold part 31, 32. While the illustrated example shows that a second fold part 32 has been formed, simply flipping the unit mats 10 upside down would show that a first fold part 31 has been formed.

On at least one of the two unit mats 10, an untrimmed attachment part 33 may be formed. As illustrated in FIG. 7B, the attachment part 33 of this unit mat 10 may be fused by way of heat or high-frequency waves with the unit fold part 41 of another unit mat 10. Here, the portion where the unit fold part 41 and the attachment part 33 are fused together may form the second or first fold part 32, 31. While the illustrated example shows that a first fold part 31 has been formed, simply flipping the unit mats 10 upside down would show that a second fold part 32 has been formed.

In this manner, three unit mats 10 may be connected. The center unit mat 10 may be connected to one side unit mat 10 by the first fold part 31 located at the upper end on one side, and may be connected to the other side mat unit 10 by the second fold part 32 located at the lower end on the other side, so that the three unit mats 10 may be easily folded in a zigzag form. While the illustrated example shows three unit mats 10 connected together, the invention is not limited thus. For example, operation S6 can be performed several times so that four or more unit mats 10 are connected in zigzag form.

It is to be appreciated that the present invention described above is not to be limited by the embodiments set forth above or by the accompanying drawings. It should be apparent to those of ordinary skill in the field of art to which the present invention pertains that various substitutions, alterations, and modifications can be derived without departing from the technical spirit of the present invention.

What is claimed is:

1. A method of manufacturing a folding mat, the folding mat comprising a plurality of unit mats, each of the unit mats comprising a unit filler shaped as a quadrilateral block and a unit outer skin enveloping the unit filler, the plurality of unit mats stacked in a zigzag form by way of a first and a second fold part formed on an upper end on one side and a lower end on the other side of the unit outer skin, the method comprising:
suctioning a first film onto a lower mold, the lower mold having a downwardly concave slit groove extending in a lengthwise direction at one end of a bottom surface of a quadrilateral cavity formed therein, the first film suctioned to be in tight contact with the bottom surface of the cavity, an inner wall of the slit groove, and an entrance periphery of the slit groove, such that a portion of the first film placed in tight contact with the slit groove forms a unit fold part;
inserting the unit filler over the first film placed in tight contact with the cavity of the lower mold;
disposing a second film on an upper side of the lower mold to cover the unit filler, the second film disposed such that an edge part of the second film overlaps an edge part of the first film positioned in the entrance periphery of the cavity of the lower mold;
attaching the edge parts of the first and the second films together by using an upper mold mating with the lower mold;
trimming an attachment part of the unit mats thus fabricated, the attachment part trimmed such that all of or a portion of the attachment part is trimmed;
fusing the unit fold part of the unit mat with the unit fold part of an adjacent unit mat by way of heat or high-frequency waves; and
fusing the attachment part of one of the two connected unit mats with the attachment part or the unit fold part of another unit mat by way of heat or high-frequency waves.

2. The method of claim 1, wherein the unit filler is made from a polyethylene expanded foam member, the first and the second films forming the unit outer skin are made from thermoplastic polyurethane (TPU), and the attachment part of the first and second films is formed by the edge parts fused together by high-frequency fusion.

3. A folding mat manufactured by the method of claim 1.

4. A folding mat manufactured by the method of claim 2.
